(19) United States
(12) Patent Application Publication
(10) Pub. No.: US 2026/0032800 A1
(43) Pub. Date: Jan. 29, 2026

(54) ILLUMINATION CONTROL METHOD

(71) Applicant: SEIKO EPSON CORPORATION, Tokyo (JP)

(72) Inventors: Fumitaka KATO, MATSUMOTO-SHI (JP); Shinnosuke ARAKI, MATSUMOTO-SHI (JP)

(21) Appl. No.: 19/279,270

(22) Filed: Jul. 24, 2025

(30) Foreign Application Priority Data
Jul. 26, 2024 (JP) 2024-120948

(51) Int. Cl. H05B 47/175

(52) U.S. Cl. CPC H05B 47/198

(57) ABSTRACT

An illumination control method includes pairing a smartphone with a projector, reading a QR code provided on an illumination device by the smartphone, transmitting the QR code to the projector by the smartphone, pairing the projector with the illumination device based on the QR code, and transmitting a pairing completion signal to the smartphone by the projector.

The present application is based on, and claims priority from JP Application Serial Number 2024-120948, filed Jul. 26, 2024, the disclosure of which is hereby incorporated by reference herein in its entirety.

### BACKGROUND

### 1. Technical Field

The present disclosure relates to an illumination control method.

### 2. Related Art

JP-A-2015-11981 discloses a method of reading a QR code (registered trademark) of a light emitting device using a reading device and controlling light emission of the light emitting device by a control device using a control protocol in a correspondence relationship with the light emitting device.

JP-A-2015-11981 is an example of the related art.

However, in the configuration described in JP-2015-11981, there is a problem that, when the light emitting device and the control device do not conform to the same control protocol standard, the light emitting device is uncontrollable by the control device.

### SUMMARY

An illumination control method according to an aspect of the present disclosure includes pairing an information processing device and a display device, reading an identification code provided on a lamp by the information processing device, transmitting the identification code to the display device by the information processing device, pairing the display device with the lamp based on the identification code, and transmitting a pairing completion signal to the information processing device by the display device.

### BRIEF DESCRIPTION OF THE DRAWINGS

FIG. 1 is a schematic diagram showing a configuration of an illumination control system.

FIG. 2 is a block diagram showing the configuration of the illumination control system.

FIG. 3 is a flowchart showing an illumination control method.

FIG. 4 is a schematic diagram showing a part of the illumination control method.

FIG. 5 is a schematic diagram showing a part of the illumination control method.

FIG. 6 is a schematic diagram showing a part of the illumination control method.

FIG. 7 is a schematic diagram showing a part of the illumination control method.

FIG. 8 is a schematic diagram showing a part of the illumination control method.

FIG. 9 is a schematic diagram showing a part of the illumination control method.

### DESCRIPTION OF EMBODIMENTS

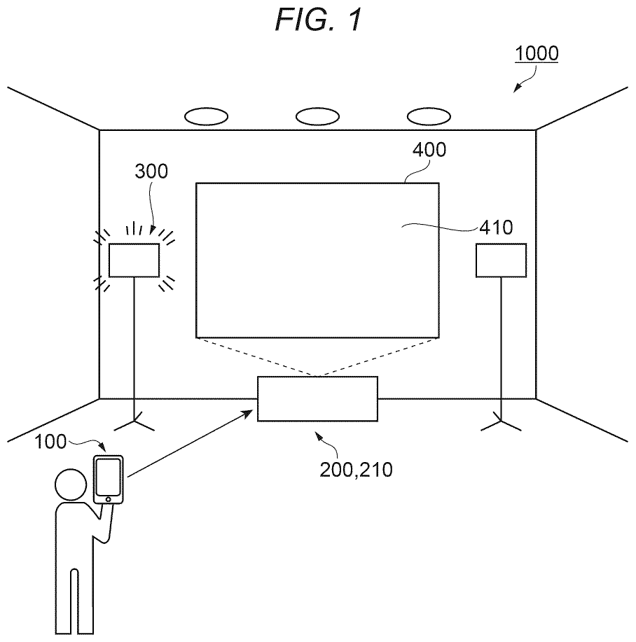

Hereinafter, an illumination control method will be described with reference to the drawings. First, a configuration of an illumination control system 1000 will be described with reference to FIG. 1.

As shown in FIG. 1, the illumination control system 1000 includes a smartphone 100 as an information processing device, a projector 200 as a display device, and an illumination device 300 as a lamp.

The illumination control system 1000 can associate the smartphone 100 with the illumination device 300 via the projector 200 even when the smartphone 100 does not support the control protocol standard of the illumination device 300. In other words, for example, the smartphone 100 can be operated to turn on or off the illumination device 300 or change the color or brightness of the illumination device 300.

The projector 200 includes a projection unit 250 for projecting image information or the like input from the outside on a projection surface 400. A projection image 410 based on the image information is displayed on the projection surface 400. Examples of the projection surface 400 include a room wall, a screen, and a whiteboard.

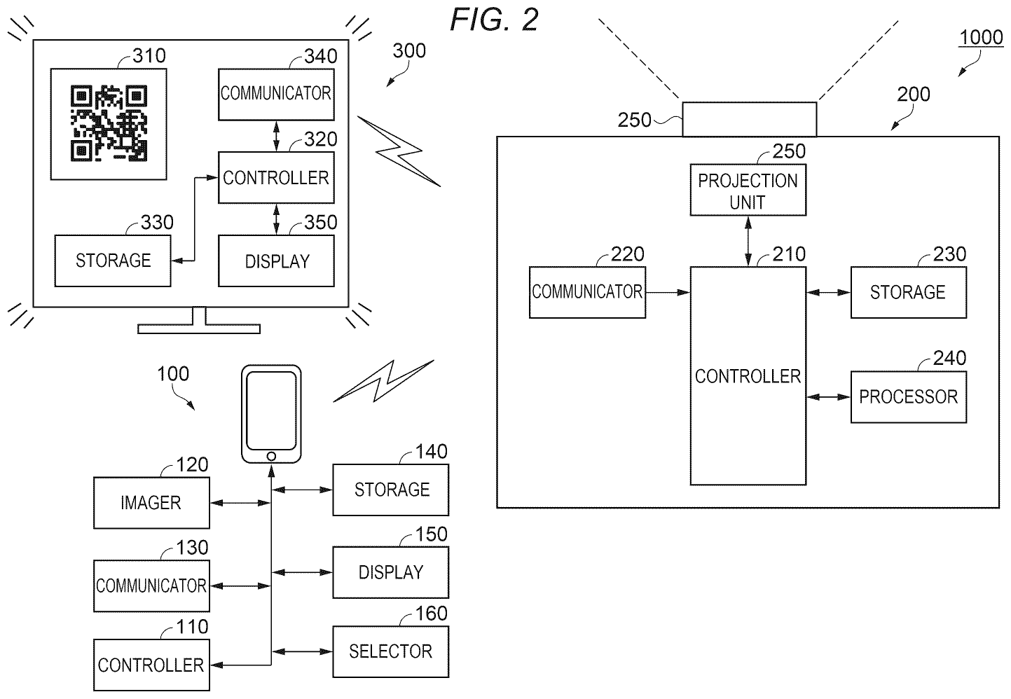

Next, an electrical configuration of the illumination control system 1000 will be described with reference to FIG. 2.

As shown in FIG. 2, the illumination control system 1000 has the smartphone 100, the projector 200, and the illumination device 300 as described above.

The smartphone 100 includes a controller 110, an imager 120, a communicator 130, a storage 140, a display 150, and a selector 160.

The controller 110 has one or more processors, and operates in accordance with a control program stored in the storage 140 and thus comprehensively controls the operation of the smartphone 100.

The imager 120 images the identification code provided on the illumination device 300. Examples of the imager 120 include a camera including a charge coupled device (CCD) sensor or a complementary metal oxide semiconductor (CMOS) sensor. Examples of the identification code include a QR code 310 and a barcode.

The communicator 130 transmits and receives signals to and from a communicator 220 of the projector 200. The communicator 130 makes, for example, near field communication such as Bluetooth (registered trademark).

The storage 140 has memories such as a random-access memory (RAM) and a read-only memory (ROM). The RAM is used to temporarily store various data and the like, and the ROM stores a control program, control data and the like for controlling the operation of the smartphone 100.

The display 150 includes, for example, a display panel such as a liquid crystal display (LCD), and displays, for example, a communication state with the projector 200.

The selector 160 selects, for example, whether to turn on or off the illumination device 300, whether to increase or decrease the brightness of the illumination device 300, or which color is to be displayed.

The projector 200 includes a controller 210, a communicator 220, a projection unit 250, a storage 230, and a processor 240.

The controller 210 has one or more processors, and operates in accordance with a control program stored in the storage 230 and thus comprehensively controls the operation of the projector 200.

The communicator 220 transmits and receives signals to and from the communicator 130 of the smartphone 100 and a communicator 340 of the illumination device 300. The communicator 220 makes, for example, near field communication such as Bluetooth.

The storage 230 has memories such as a random access memory (RAM) and a read only memory (ROM). The RAM is used to temporarily store various data and the like, and the ROM stores a control program, control data and the like for controlling the operation of the projector 200. The processor 240 executes each processing based on an instruction from the controller 210.

Although not illustrated, the projection unit 250 has a light source, a liquid crystal light valve serving as a light modulation device, a projection optical system, a light valve driver, and the like. The projection unit 250 modulates light emitted from the light source with the liquid crystal light valve to form image light, projects the image light from the projection optical system including at least one of a lens and a mirror, and thus displays the projection image 410 on the projection surface 400.

The illumination device 300 includes the QR code 310, a controller 320, a storage 330, a communicator 340, and a light emitter 350.

The QR code 310 is provided on the illumination device 300. The QR code 310 is a two-dimensional code. The QR code 310 is attached to a place where the smartphone 100 can capture an image on the illumination device 300.

The controller 320 has one or more processors, and operates in accordance with a control program stored in the storage 330 and thus comprehensively controls the operation of the illumination device 300.

The storage 330 has memories such as a random access memory (RAM) and a read only memory (ROM). The RAM is used to temporarily store various data and the like, and the ROM stores a control program, control data, and the like for controlling the operation of the illumination device 300.

The communicator 340 transmits and receives signals to and from the communicator 220 of the projector 200. The communicator 340 makes, for example, near field communication such as Bluetooth.

The light emitter 350 is a light emitting device whose color, brightness, and the like change based on light emission data. The light emitter 350 includes a light emitting element such as a light emitting diode (LED). For example, the light emitter 350 preferably includes one or more red LEDs that emit red light, one or more green LEDs that emit green light, and one or more blue LEDs that emit blue light.

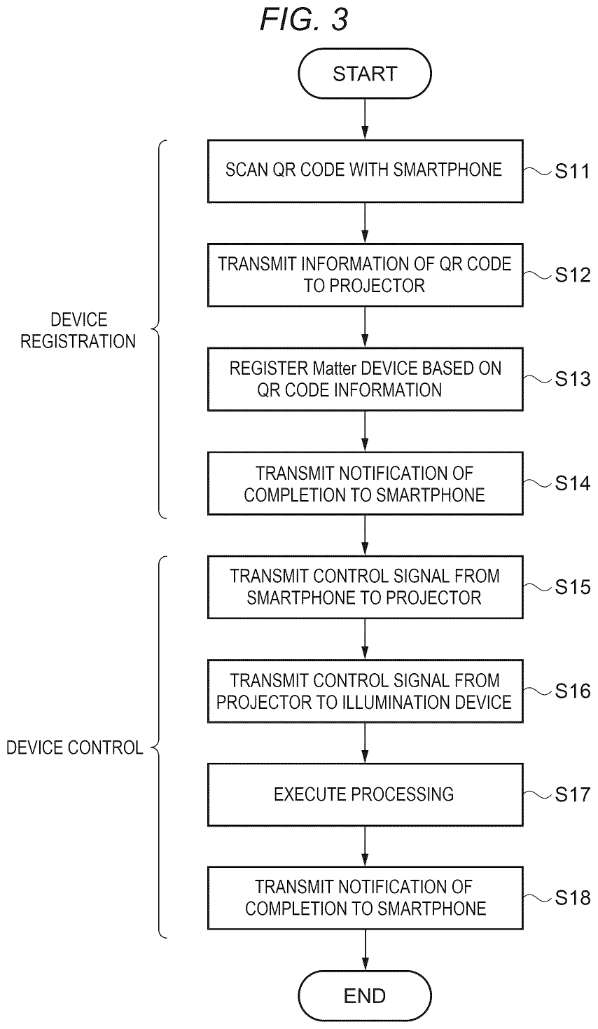

Next, an illumination control method for the illumination control system 1000 will be described with reference to FIGS. 3 to 9.

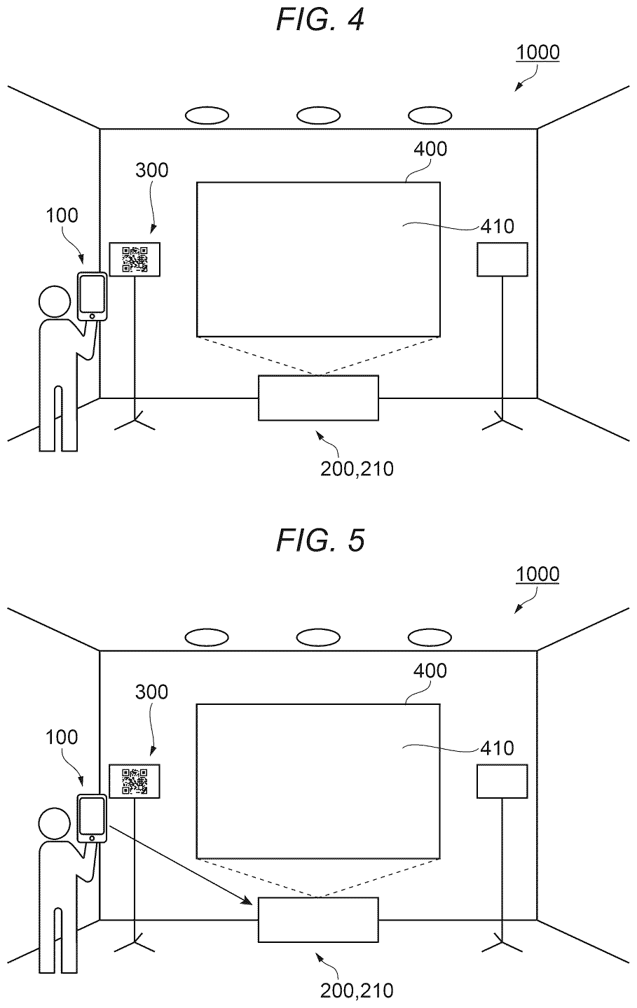

As illustrated in FIG. 3, in step S11, the smartphone 100 scans the QR code 310. The smartphone 100 and the projector 200 are paired in advance. Specifically, as illustrated in FIG. 4, a user holds the smartphone 100 close to the QR code 310 attached to the illumination device 300 and scans the QR code 310. This enables the smartphone 100 to read the identification code based on the QR code 310. The controller 110 of the smartphone 100 stores the read identification code in the storage 140.

Then, in step S12, the information of the QR code 310 is transmitted to the projector 200. Specifically, as shown in FIG. 5, the controller 110 of the smartphone 100 causes the communicator 130 to transmit the identification code to the communicator 220 of the projector 200. The controller 210 of the projector 200 causes the storage 230 to store the identification code received via the communicator 220.

Then, in step S13, a Matter device is registered based on the information of the QR code 310. The Matter device is the illumination device 300. Matter is one of the control protocols. The projector 200 is paired with the illumination device 300 based on the identification code stored in the storage 230.

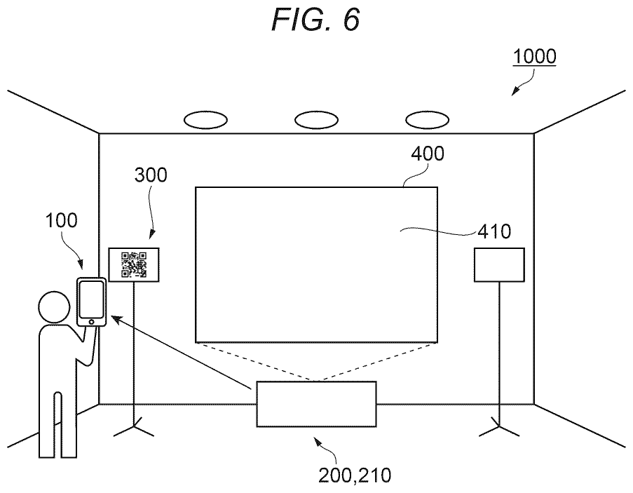

Then, in step S14, a notification of completion is transmitted to the smartphone 100. Specifically, as shown in FIG. 6, the controller 210 of the projector 200 causes the communicator 220 to transmit a pairing completion signal indicating that the pairing with the illumination device 300 is completed to the communicator 130 of the smartphone 100. Thus, a message indicating that the pairing between the projector 200 and the illumination device 300 is completed is displayed on the display 150 of the smartphone 100.

Since the projector 200 and the illumination device 300 are thus paired based on the identification code, the illumination device 300 and the smartphone 100 can be associated with each other via the projector 200 even when the smartphone 100 does not support the control protocol standard of the illumination device 300. That is, the illumination device 300 can be operated according to the operation of the smartphone 100. Thus, the registration of the device is completed.

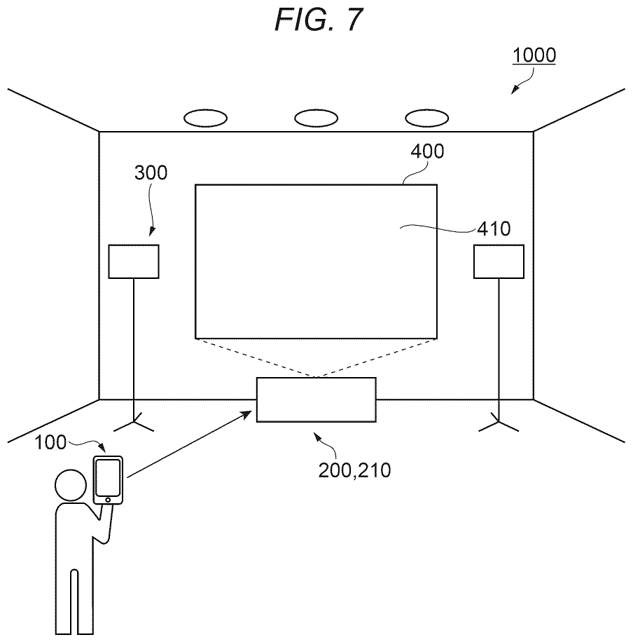

Next, a method of controlling the illumination device 300 will be described. In step S15, a control signal is transmitted from the smartphone 100 to the projector 200. Specifically, as shown in FIG. 7, the controller 110 of the smartphone 100 causes the communicator 130 to transmit a control signal for controlling the illumination device 300 to the communicator 220 of the projector 200. Examples of the control signal include a signal for turning on or off the power of the illumination device 300, a signal of the brightness of the light emitter 350, a signal of the color of the light emitter 350, and a signal of the turn-on time or the blinking time of the light emitter 350.

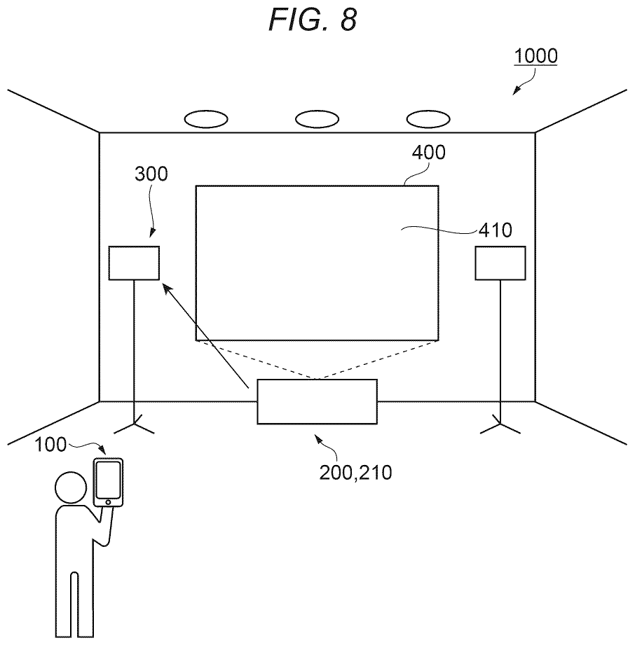

Then, in step S16, the control signal transmitted from the projector 200 to the illumination device 300. Specifically, as shown in FIG. 8, the controller 210 of the projector 200 causes the communicator 220 to transmit the received control signal to the communicator 340 of the illumination device 300. That is, an instruction of the smartphone 100, that is, the control signal is transmitted to the illumination device 300 via the projector 200.

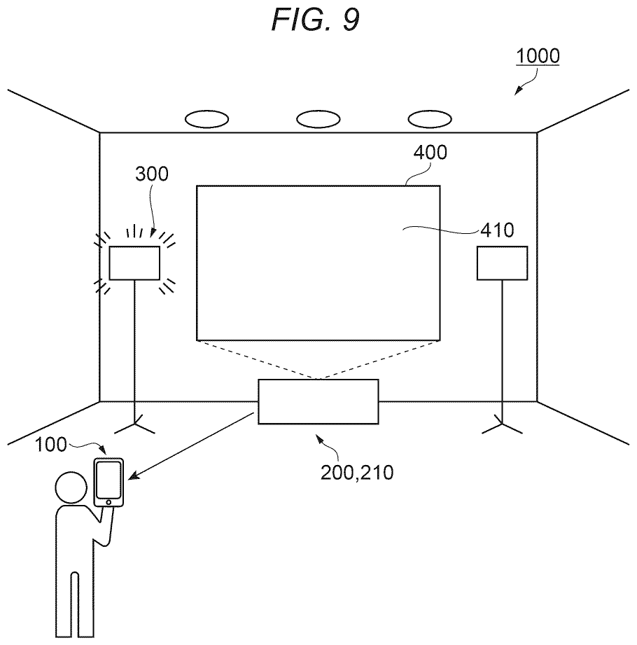

Then, in step S17, processing is executed based on the control signal. Specifically, as illustrated in FIG. 9, the controller 320 of illumination device 300 causes the light emitter 350 to perform processing based on the received control signal. As the processing of the embodiment, for example, the light emitter 350 of illumination device 300 is turned on.

Then, in step S18, a notification of completion is transmitted to the smartphone 100. Specifically, as shown in FIG. 9, the controller 210 of the projector 200 causes the communicator 220 to transmit a completion signal indicating that the execution of the process is completed to the communicator 130 of the smartphone 100. The display 150 of the smartphone 100 displays a message indicating that the light emitter 350 of the illumination device 300 is turned on.

As described above, even when the smartphone 100 does not support the control protocol standard of the illumination device 300, the illumination device 300 can be operated from the smartphone 100 via the projector 200. Thus, the control of the illumination device 300 is completed.

As described above, the illumination control method according to the embodiment includes pairing the smartphone 100 with the projector 200, reading the QR code 310 provided on the illumination device 300 by the smartphone 100, transmitting the QR code to the projector 200 by the smartphone 100, pairing the projector 200 with the illumination device 300 based on the QR code 310, and transmitting the pairing completion signal to the smartphone 100 by the projector 200.

According to the method, since the projector 200 and the illumination device 300 are paired based on the QR code 310, the illumination device 300 and the smartphone 100 can be associated with each other via the projector 200 even when the smartphone 100 does not support the control protocol standard (for example, Matter) of the illumination device 300. That is, the user can control the illumination device 300 by operating the smartphone 100.

Further, the illumination control method according to the embodiment preferably includes transmitting the control signal for controlling the illumination device 300 to the projector 200 by the smartphone 100, transmitting the control signal to the illumination device 300 by the projector 200, and executing predetermined control based on a control instruction of the control signal by the illumination device 300. According to the method, since the projector 200 and the illumination device 300 are paired based on the QR code 310, even when the smartphone 100 does not support the control protocol standard of the illumination device 300, the illumination device 300 and the smartphone 100 can be associated with each other via the projector 200. That is, the user can control the illumination device 300 by operating the smartphone 100.

A modification example of the above described embodiment will be described below.

As described above, not limited to controlling of the illumination device 300 on the left side with respect to the projection surface 400, control of an illumination device on the right side may be employed. Similarly, when the right illumination device is controlled, the QR code of the right illumination device is scanned and the same method is performed.

As described above, the control protocol is not limited to Matter, and other control protocols at any common standard may be used.

The present disclosure will be summarized below as appendices.

(Appendix 1) An illumination control method includes pairing an information processing device with a display device, reading an identification code provided on a lamp by the information processing device, transmitting the identification code to the display device by the information processing device, pairing the display device with the lamp based on the identification code, and transmitting a pairing completion signal to the information processing device by the display device.

According to the method, since the display device and the lamp are paired based on the identification code, the lamp and the information processing device can be associated with each other via the display device even when the information processing device does not support the control protocol standard (for example, Matter) of the lamp. That is, the lamp can be controlled according to the operation of the information processing device.

(Appendix 2) The illumination control method according to Appendix 1, includes transmitting a control signal for controlling the lamp to the display device by the information processing device, transmitting the control signal to the lamp by the display device, and executing predetermined control based on a control instruction of the control signal by the lamp. According to the method, since the display device and the lamp are paired based on the identification code, even when the information processing device does not support the control protocol standard of the lamp, the lamp and the information processing device can be associated with each other via the display device. That is, the lamp can be controlled according to the operation of the information processing device.

What is claimed is:

1. An illumination control method comprising:
pairing an information processing device and a display device;
reading an identification code provided on a lamp by the information processing device;
transmitting the identification code to the display device by the information processing device;
pairing the display device with the lamp based on the identification code; and
transmitting a pairing completion signal to the information processing device by the display device.

2. The illumination control method according to claim 1, further comprising:
transmitting a control signal for controlling the lamp to the display device by the information processing device;
transmitting the control signal to the lamp by the display device; and
executing first control based on a control instruction of the control signal by the lamp.

3. The illumination control method according to claim 2, wherein
the first control includes at least one of control for turning on the lamp, control for changing brightness of the lamp, control for turning off the lamp, and control for changing a color of the lamp.

4. The illumination control method according to claim 2, wherein
the control signal includes at least one of a signal related to a turn-on time of the lamp and a signal related to a blinking time of the lamp.

5. The illumination control method according to claim 2, further comprising displaying a message indicating that the lamp executes the first control by the information processing device.
